(19) United States
(12) Patent Application Publication
(10) Pub. No.: US 2017/0183141 A1
(43) Pub. Date: Jun. 29, 2017

(54) ANTIBACTERIAL WATER-PRESERVING CONTAINER AND METHOD OF MANUFACTURING THE SAME

(71) Applicant: Silver Future Co., Ltd., Saitama-ken (JP)

(72) Inventor: Akiko HIRAI, Saitama-ken (JP)

(73) Assignee: Silver Future Co., Ltd., Saitama-ken (JP)

(21) Appl. No.: 15/135,037

(22) Filed: Apr. 21, 2016

(30) Foreign Application Priority Data
Dec. 23, 2015 (KR) 10-2015-0185124

(51) Int. Cl. B65D 81/28; C02F 1/50; C01B 21/06; A01N 59/16; B65D 1/02; B05D 1/02

(52) U.S. Cl. CPC B65D 81/28; B65D 1/0207; B05D 1/02; C01B 21/0615; A01N 59/16; C02F 1/505; C02F 2303/04; C02F 2307/02

(57) ABSTRACT

Disclosed is a water-preserving container including a first silver nitride (Ag₃N) sintered-surface layer on a portion of an inner wall or the entire inner wall of the water-preserving container, and a second silver nitride sintered-surface layer on a portion of a lip contact part or the entire lip contact part of the water-preserving container. The water-preserving container prevents the proliferation of bacteria generated according to use and destroys the bacteria, sterilizes and purifies polluted water, and exhibits an early antibacterial effect within 2 hours.

### CROSS REFERENCE TO RELATED APPLICATION

This application claims the benefit of Korean Patent Application No. 10-2015-0185124, filed Dec. 23, 2015, which is hereby incorporated by reference in its entirety into this application.

### BACKGROUND OF THE INVENTION

1. Technical Field

The present invention relates to an antibacterial water-preserving container and a method of manufacturing the same.

2. Description of the Related Art

Typical water-preserving containers, for example, portable containers for water and beverages, such as vacuum bottles and water bottles, are known to have a drawback in that various bacteria or oral bacteria (Streptococcus mutans), which arise from pollution of a portion coming into contact with lips of a user or saliva of the user, or which are attached to fingers, are mixed with water in the water bottle or attached to the water bottle when the user drinks water from the water bottle, thereby allowing various bacteria to proliferate in the water bottle. Further, it has been pointed out that there is a risk of attachment of harmful food-poisoning bacteria, such as E. coli or Streptococcus mutans, into the water bottle, or allowing putrefactive bacteria to proliferate in the water bottle. Water bottles having an effective function of preventing bacteria from proliferating, or of destroying and eliminating bacteria, have not yet been released to date.

The main reason is considered to be that, since a conventional, heat-retaining vacuum water bottle mainly contains hot water at high temperatures and the main function of the vacuum water bottle is to minimize the reduction in temperature over time, it is mistakenly believed that various bacteria have difficulty surviving in hot water contained in the water bottle, and thus the sanitation of the water in the water bottle is maintained.

However, when the temperature of the water is reduced to a temperature of water that is capable of being drunk by humans, particularly, a temperature lower than body temperature, bacteria actively proliferate. Further, recently, beverages including sport drinks are more frequently stored at room temperature or cold temperatures than hot temperature, depending on the season, and accordingly, pollution of the liquid in the container by the bacteria has attracted attention, and symptoms such as diarrhea have occurred.

Particularly, children frequently drink beverages from the same bottle, and thus problems related to pollution of water, for example, by Streptococcus mutans in the bottle are increasing. Accordingly, there is increased expectation of the development of a water bottle having water purification and water quality maintaining functions.

A typical antibacterial ability test requires that antibacterial effect be achieved within a reference time of 24 or 48 hours. However, in practice, a user is considered to expect an antibacterial effect, by which harmful bacteria in a water-preserving container, including a water bottle and a vacuum bottle, are destroyed within at least 3 hours.

Harmful bacteria start to proliferate when harmful bacteria are accidentally mixed with beverages in the water bottle or the vacuum bottle, but at the same time harmful bacteria need to be prevented from proliferating, that is, need to be destroyed. Further, in consideration of the period ranging from the time of filling the container with a beverage, to initiation of drinking, or to finishing of drinking, the reference time of 24 hours is very long from the standpoint of common sense, and the water in the water bottle is expected to have already been drunk within 24 hours.

Therefore, from the standpoint of common sense, the antibacterial ability needs to be confirmed in an antibacterial test that an antibacterial ability of completely destroying harmful bacteria, or securing a viable cell count of 100 cells/cc or less within, at the latest, 3 hours after filling the container with water, is realized in a short time.

The antibacterial function of silver has been known for a long period of time to be realized by silver oligodynamic action, activating oxygen that is in contact with the silver surface. The history of using silver with this main factor in dishes or to store beverages is long, and the antibacterial and bacteria-reducing functions of silver are considered to be obtained not by so-called chemicals but through active oxidation. Needless to say, silver is not at all harmful to humans, and does not affect bacteria that are beneficial to humans, for example, Lactobacillus, but has strong antibacterial and sterilizing effects on food-poisoning bacteria and anaerobic bacteria, which are harmful to humans, due to active oxidation of the surface thereof, and the silver oligodynamic action is known to have safe antibacterial and sterilizing effects.

Meanwhile, Korean Registered Utility Model No. 20-0377167 discloses an antibacterial silver container that is not discolored. However, the aforementioned Korean Registered Utility Model describes only an antibacterial effect obtained after 24 hours by using pure silver powder having a nano size as a component having an antibacterial function, but not an early antibacterial effect obtained within about 3 hours.

In the present invention, various efforts have been made in order to realize a sterilizing ability in a short time, but only unsatisfactory results were obtained when using pure silver, as in the following. Meanwhile, 100% sterilization was obtained after 2 hours or more only when silver-sintered products prepared under a nitrogen gas atmosphere were used, resulting in useful proof.

### SUMMARY OF THE INVENTION

Accordingly, the present invention has been made keeping in mind the above problems occurring in the related art, and an object of the present invention is to provide a water-preserving container which prevents the proliferation of bacteria generated according to use and destroys the bacteria in a short time.

Another object of the present invention is to provide a water-preserving container which sterilizes and purifies water polluted by bacteria.

Still another object of the present invention is to provide a water-preserving container that exhibits an early antibacterial effect within 2 hours.

In order to accomplish the above objects, the present invention provides a water-preserving container which may comprise a first silver nitride (Ag₃N) sintered-surface layer on a portion of an inner wall or the entire inner wall of the water-preserving container, and which may comprise a second silver nitride sintered-surface layer on a portion of a lip contact part or the entire lip contact part of the water-preserving container.

In an embodiment of the present invention, a material of the water-preserving container may comprise a material selected from among metal, glass, ceramics, minerals, plastics, and a combination thereof.

In the embodiment of the present invention, the water-preserving container may be selected from among a mono-layered or two-layered (vacuum) bottle, a water bottle, a cup, a tumbler, a kettle, an electric pot, and a water tank.

In the embodiment of the present invention, a portion of the inner wall or the entire inner wall beneath the first silver nitride sintered-surface layer, a portion of the lip contact part or the entire lip contact part beneath the second silver nitride sintered-surface layer, or a portion of the inner wall or the entire inner wall beneath the first silver nitride sintered-surface layer and a portion of the lip contact part or the entire lip contact part beneath the second silver nitride sintered-surface layer may have a coarse surface.

In the embodiment of the present invention, the coarse surface may be formed by sandblasting.

In the embodiment of the present invention, the first silver nitride sintered-surface layer may have a thickness of 0.1 to 20 μm, and the second silver nitride sintered-surface layer may have a thickness of 0.1 to 20 μm.

In the embodiment of the present invention, a portion of the inner wall or the entire inner wall, a portion of the lip contact part or the entire lip contact part, or a portion of the inner wall or the entire inner wall and a portion of the lip contact part or the entire lip contact part may include a material including the plastics, and may be integrally formed with the first silver nitride sintered-surface layer, the second silver nitride sintered-surface layer, or each of the first silver nitride sintered-surface layer and the second silver nitride sintered-surface layer.

In the embodiment of the present invention, the integrally formed inner wall and first silver nitride sintered-surface layer, the integrally formed lip contact part and second silver nitride sintered-surface layer, or each of the integrally formed inner wall and first silver nitride sintered-surface layer and the integrally formed lip contact part and second silver nitride sintered-surface layer may include 1 to 40 parts by weight of particles including a silver nitride sintered-surface layer based on 100 parts by weight of the plastics.

In the embodiment of the present invention, the particles including the silver nitride sintered-surface layer may be exposed on the surface of the first silver nitride sintered-surface layer, the second silver nitride sintered-surface layer, or both the first silver nitride sintered-surface layer and the second silver nitride sintered-surface layer.

In the embodiment of the present invention, the particles including the silver nitride sintered-surface layer may be exposed on the surface of the first silver nitride sintered-surface layer, the second silver nitride sintered-surface layer, or both the first silver nitride sintered-surface layer and the second silver nitride sintered-surface layer by sandblasting.

In the embodiment of the present invention, inner cores of the particles including the silver nitride sintered-surface layer may include talc particles.

In the embodiment of the present invention, the weight ratio of the talc particles to the silver nitride sintered-surface layer may be 100:1 to 10.

In order to accomplish the above objects, the present invention also provides a method of manufacturing a water-preserving container including an inner wall and a lip contact part, which may comprise a first process of adding and dissolving silver salt compound powder to water or a polar organic solvent to manufacture a silver salt-dissolved solution, a second process of applying the silver salt-dissolved solution on a portion of the inner wall or the entire inner wall and a portion of the lip contact part or the entire lip contact part of the water-preserving container, and a third process of sintering a silver salt compound applied on the inner wall and the lip contact part under a nitrogen atmosphere to form a first silver nitride sintered-surface layer on a portion of the inner wall or the entire inner wall and a second silver nitride sintered-surface layer on a portion of the lip contact part or the entire lip contact part.

In the embodiment of the present invention, the material of the inner wall and the lip contact part may comprise a material selected from among metal, glass, ceramics, minerals, and a combination thereof.

In the embodiment of the present invention, 1 to 5 parts by weight of the silver salt compound powder may be added to 100 parts by weight of water or the polar organic solvent in the first process.

In the embodiment of the present invention, the silver salt compound may be selected from among silver carbonates, silver chlorates, silver chlorides, silver chromates, silver vanadates, silver manganates, silver nitrates, silver nitrites, silver perchlorates, silver phosphates, silver acetates, and mixtures thereof.

In the embodiment of the present invention, the sintering temperature may be 440° C. or more in the third process. The sintering time may be 60 to 600 min in the third process.

In the embodiment of the present invention, a coarse surface may be formed on a portion of the inner wall or the entire inner wall, a portion of the lip contact part or the entire lip contact part, or a portion of the inner wall or the entire the inner wall and a portion of the lip contact part or the entire lip contact part before the second process, and the silver salt-dissolved solution may be applied on a portion of the coarse surface or the entire coarse surface in the second process.

In the embodiment of the present invention, the coarse surface may be formed by sandblasting.

In the embodiment of the present invention, the first silver nitride sintered-surface layer may be formed to a thickness of 0.1 to 20 μm and the second silver nitride sintered-surface layer may be formed to a thickness of 0.1 to 20 μm.

In order to accomplish the above objects, the present invention also provides a method of manufacturing a water-preserving container including an inner wall and a lip contact part, which may comprise a first process of adding and dissolving 1 to 5 parts by weight of silver salt compound powder to 100 parts by weight of water or a polar organic solvent to manufacture a silver salt-dissolved solution, a second process of applying the silver salt-dissolved solution on a portion of the inner wall or the entire inner wall and a portion of the lip contact part or the entire lip contact part of the water-preserving container, and a third process of sintering a silver salt compound applied on the inner wall and the lip contact part under a nitrogen atmosphere or the atmosphere to form a first silver nitride sintered-surface layer or silver oxide sintered-surface layer on a portion of the inner wall or the entire inner wall and a second silver nitride sintered-surface layer or silver oxide sintered-surface layer on a portion of the lip contact part or the entire lip contact part.

In order to accomplish the above objects, the present invention also provides a method of manufacturing a water-preserving container including an inner wall and a lip contact part, which may comprise a first process of adding talc powder and silver salt compound powder to water or a polar organic solvent, mixing them, and sintering a silver salt compound under a nitrogen atmosphere to manufacture talc particles including a silver nitride sintered-surface layer, a second process of mixing and heating a plastic material and the talc particles including the silver nitride sintered-surface layer to manufacture pellets, a third process of forming the inner wall, the lip contact part, or both the inner wall and the lip contact part with the pellets, and a fourth process of subjecting a portion of the inner wall or the entire inner wall, a portion of the lip contact part or the entire lip contact part, or a portion of the inner wall or the entire inner wall and a portion of the lip contact part or the entire lip contact part to sandblasting to expose the talc particles including the silver nitride sintered-surface layer on a surface of the inner wall, the lip contact part, or both the inner wall and the lip contact part.

A method of manufacturing a water-preserving container including an inner wall and a lip contact part may comprise: a first process of adding talc powder and silver salt compound powder to water or a polar organic solvent, mixing them, and sintering a silver salt compound at a temperature of 440° C. or more under a nitrogen atmosphere to manufacture talc particles including a silver nitride sintered-surface layer, a second process of mixing and heating a plastic material and the talc particles including the silver nitride sintered-surface layer to manufacture pellets, a third process of injection molding the lip contact part with the pellets, and a fourth process of subjecting a surface of a necessary portion of the lip contact part to sandblasting to expose the talc particles including the silver nitride sintered-surface layer on the surface of the necessary portion of the lip contact part.

In the embodiment of the present invention, the weight ratio of the talc powder to the silver salt compound powder may be 100:1 to 10, and the weight ratio of the mixture of the talc powder and the silver salt compound powder to the water or the polar organic solvent may be 1 to 70:100 in the first process.

In the embodiment of the present invention, the silver salt compound may be selected from among silver carbonates, silver chlorates, silver chlorides, silver chromates, silver vanadates, silver manganates, silver nitrates, silver nitrites, silver perchlorates, silver phosphates, silver acetates, and mixtures thereof.

In the embodiment of the present invention, the sintering temperature may be 440° C. or more in the first process. The sintering time may be 60 to 600 min in the first process.

In the embodiment of the present invention, the weight ratio of the plastic material to the talc particles including the silver nitride sintered-surface layer may be 100:1 to 40 in the second process.

In order to accomplish the above objects, the present invention also provides a method of manufacturing a water-preserving container including an inner wall and a lip contact part, which may comprise a first process of adding talc powder and silver salt compound powder to water or a polar organic solvent, mixing them, and sintering a silver salt compound under a nitrogen atmosphere or the atmosphere to manufacture talc particles including a silver nitride sintered-surface layer or silver oxide sintered-surface layer, wherein the weight ratio of the talc powder to the silver salt compound powder is 100:1 to 10 and the weight ratio of the mixture of the talc powder and the silver salt compound powder to the water or the polar organic solvent is 1 to 70:100, a second process of mixing and heating a plastic material and the talc particles including the silver nitride sintered-surface layer or the silver oxide sintered-surface layer to manufacture pellets, a third process of forming the inner wall, the lip contact part, or both the inner wall and the lip contact part with the pellets, and a fourth process of subjecting a portion of the inner wall or the entire inner wall, a portion of the lip contact part or the entire lip contact part, or a portion of the inner wall or the entire inner wall and a portion of the lip contact part or the entire lip contact part to sandblasting to expose the talc particles including the silver nitride sintered-surface layer or silver oxide sintered-surface layer on the surface of the inner wall, the lip contact part, or both the inner wall and the lip contact part.

According to the present invention, the water-preserving container prevents the proliferation of bacteria generated according to use and destroys the bacteria, sterilizes and purifies polluted water, and exhibits an early antibacterial effect within 2 hours.

Specifically, the water-preserving container according to the present invention prevents pollution by bacteria according to use, and has an ability to remove and destroy harmful bacteria belonging to anaerobic bacteria, which have low resistance to active oxidation by mainly silver, such as harmful food-poisoning bacteria, including E. coli, Salmonella, Vibrio parahaemolyticus, and Staphylococcus aureus, or Streptococcus mutans after a predetermined time (typically, after about 2 hours or more), even when water is added from a river, a lake, and a marsh to the water-preserving container in the event of an emergency.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a water-preserving container (vacuum water bottle) according to an embodiment of the present invention;

FIGS. 2, 3 and 4 are a sectional view, a side view and a perspective view, respectively, of a lip contact part of the water-preserving container (vacuum water bottle) according to an embodiment of the present invention;

FIGS. 5, 6, and 7 are pictures showing a test solution when an antibacterial test of the silver-sintered vacuum bottle of Comparative Example 1 is initiated, 3 hours after the antibacterial test is performed, and 6 hours after the antibacterial test is performed, respectively;

FIGS. 8, 9, and 10 are pictures showing a test solution when an antibacterial test of the silver oxide vacuum water bottle of Reference Example 1 is initiated, 3 hours after the antibacterial test is performed, and 6 hours after the antibacterial test is performed, respectively;

FIG. 11 is a picture showing a test solution when an antibacterial test of a silver nitride vacuum water bottle and a sterilized container made of the synthetic resin of Example 1 is initiated;

FIGS. 12, 14 and 16 are pictures showing a test solution 2 hours, 3 hours and 4 hours, respectively, after an antibacterial test of a silver nitride vacuum water bottle of Example 1 is performed; and

FIGS. 13, 15 and 17 are pictures showing a test solution 2 hours, 3 hours and 4 hours, respectively, after an antibacterial test of a sterilized container made of the synthetic resin of Example 1 is performed.

### DESCRIPTION OF THE SPECIFIC EMBODIMENTS

Water-Preserving Container

A water-preserving container according to an embodiment of the present invention may include a first silver nitride (Ag₃N) sintered-surface layer on a portion of an inner wall or the entire inner wall of the water-preserving container, and a second silver nitride sintered-surface layer on a portion of a lip contact part or the entire lip contact part of the water-preserving container.

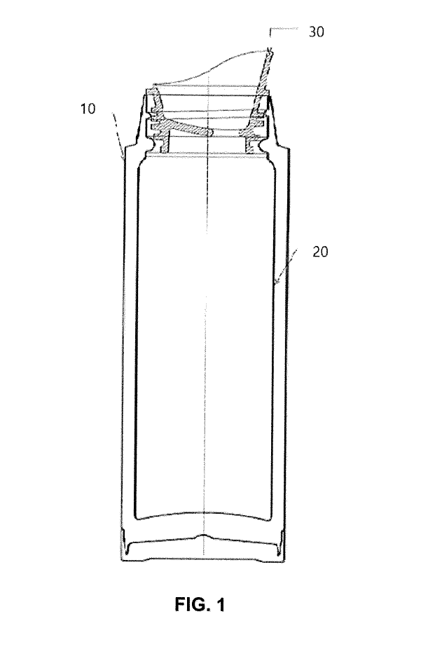

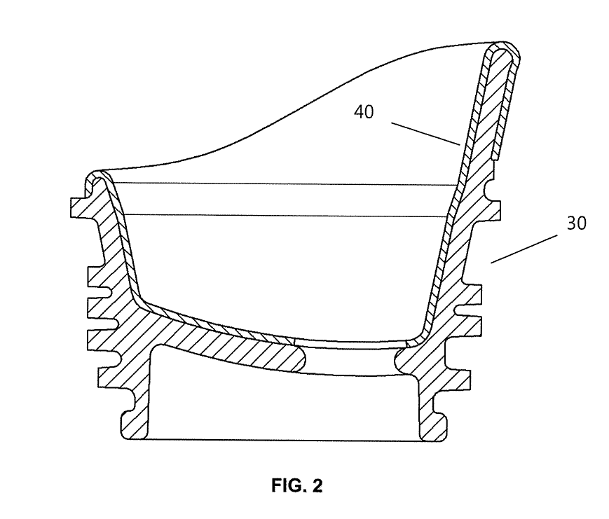

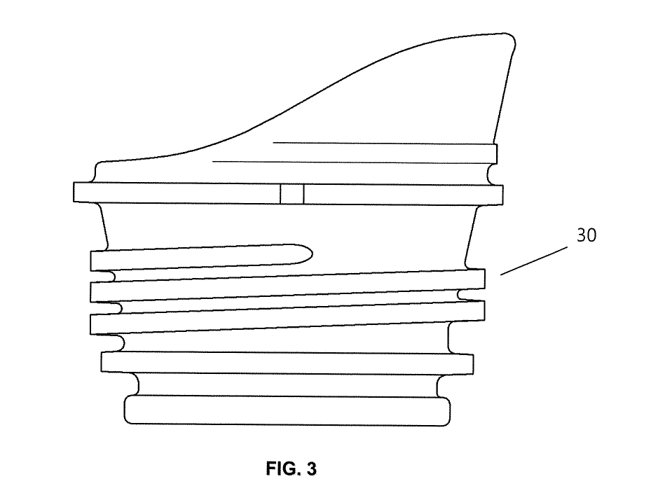

FIG. 1 shows a sectional view of the water-preserving container (vacuum water bottle) according to the embodiment of the present invention. Referring to FIG. 1, the vacuum water bottle includes an outer bottle 10, an inner bottle 20, and a lip contact part 30. The vacuum water bottle includes the first silver nitride sintered-surface layer on a portion of the inner wall or the entire inner wall of the inner bottle 20, and the second silver nitride sintered-surface layer on a portion of the lip contact part 30 or the entire lip contact part 30. FIGS. 2, 3 and 4 are a sectional view, a side view and a perspective view, respectively, of a lip contact part (30) of the water-preserving container (vacuum water bottle) according to the embodiment of the present invention.

The water-preserving container may contain natural or processed foods including water. The water-preserving container may contain liquid foods such as water, beverages, yogurt, milk, juice, coffee, tea, and alcoholic beverages, and solid-liquid mixed foods such as noodles, soup, and canned foods, but the foods are not limited thereto.

In the embodiment of the present invention, the material of the water-preserving container may comprise a material selected from among metal, glass, ceramics, minerals, plastics, and combinations thereof.

In the embodiment of the present invention, the water-preserving container may be selected from among a mono-layered or two-layered (vacuum) bottle, a water bottle, a cup, a tumbler, a kettle, an electric pot, and a water tank.

The inner wall of the water-preserving container may be a portion of the water-preserving container that contacts with foods including water when the foods are contained in a maximum or predetermined amount in the water-preserving container or when a user eats the foods, and may mainly be the side surfaces and the bottom surface inside the water-preserving container. Further, the inner wall of the water-preserving container may be a portion that does not contact with the bodies of humans or animals other than humans that eat the foods.

The lip contact part of the water-preserving container may be a portion of the water-preserving container that contacts with lips and other perioral organs, for example, the teeth, gums, palate, tongue, and mucous membranes of the cheeks, either directly or indirectly through a medium of foods including water, or saliva, etc. Further, the lip contact part may be a portion that contacts with not only the lips, but other organs around the mouth, such as the nose, the philtrum, cheeks, and the chin, or hand-related organs such as the fingers, the nails, the back of the hand, and the palm.

In the embodiment of the present invention, a portion of the inner wall or the entire inner wall beneath the first silver nitride sintered-surface layer, a portion of the lip contact part or the entire lip contact part beneath the second silver nitride sintered-surface layer, or a portion of the inner wall or the entire inner wall beneath the first silver nitride sintered-surface layer and a portion of the lip contact part or the entire lip contact part beneath the second silver nitride sintered-surface layer may have a coarse surface. When the coarse surface is present, the strength of adhesion of the silver nitride sintered-surface layer may be improved, and the antibacterial effect due to the silver nitride sintered-surface layer may be improved.

In the embodiment of the present invention, the coarse surface may be formed by sandblasting. Sandblasting is a kind of spray processing, in which glass spheres, silicon, or marine sand having a small diameter is sprayed using air or made to fall due to gravity on the surface of the material.

In the embodiment of the present invention, the first silver nitride sintered-surface layer may have a thickness of 0.1 to 20 μm and the second silver nitride sintered-surface layer may have a thickness of 0.1 to 20 μm. When the thickness is in the aforementioned range, an excellent antibacterial effect may be secured.

In the embodiment of the present invention, the first silver nitride sintered-surface layer may include silver nitrides in an amount of 50 to 100 wt %, 70 to 100 wt %, or 90 to 100 wt % based on the total weight of the first silver nitride sintered-surface layer, and the second silver nitride sintered-surface layer may include silver nitrides in an amount of 50 to 100 wt %, 70 to 100 wt %, or 90 to 100 wt % based on the total weight of the second silver nitride sintered-surface layer. When the silver nitride sintered-surface layer includes silver nitrides in an amount within any one of the aforementioned ranges, the early antibacterial property may be excellent.

When the first silver nitride sintered-surface layer, the second silver nitride sintered-surface layer, or both layers include silver nitrides in an amount of less than 100 wt %, silver compounds such as silver and silver oxides, and other impurities may be included, and an antibacterial component other than the silver compounds may be further included.

The first silver nitride sintered-surface layer, the second silver nitride sintered-surface layer, or both layers are combined in a solid state with the inner wall, the lip contact part, or both the inner wall and the lip contact part, respectively. The silver nitride sintered-surface layer may be combined with the inner wall, etc. by a known separate adhesive, or by a process of applying the solution including the silver salt compound on the inner wall, etc. and then sintering it under a nitrogen atmosphere, like the manufacturing method as will be described below, without a separate adhesive.

In the embodiment of the present invention, the first silver nitride sintered-surface layer, the second silver nitride sintered-surface layer, or both the first silver nitride sintered-surface layer and the second silver nitride sintered-surface layer may include a silver nitride sintered substance. The silver nitride sintered substance may be formed by a process of sintering the silver salt compound under a nitrogen atmosphere, like the manufacturing method that will be described below.

In the embodiment of the present invention, a portion of the inner wall or the entire inner wall, a portion of the lip contact part or the entire lip contact part, or a portion of the inner wall or the entire inner wall and a portion of the lip contact part or the entire lip contact part may include a material including the plastics, and may be integrally formed with the first silver nitride sintered-surface layer, the second silver nitride sintered-surface layer, or each of the first silver nitride sintered-surface layer and the second silver nitride sintered-surface layer.

Examples of the plastics include a thermoplastic resin, which is shaped by inserting components in a hot molten state in a frame, or a thermosetting resin, which is shaped by mixing, heating, and curing components. Specific examples include polyester, polyethylene terephthalate, polyethylene, high-density or low-density polyethylene, polyvinyl chloride, polypropylene, polystyrene, impact-resistant polystyrene, polyamide, acrylonitrile butadiene styrene, polycarbonate, polyurethane, maleimide, a urea resin, a bakelite resin, a melamine resin, melamine formaldehyde, a phenolic resin, polyepoxide, polyetherimide, polyimide, a polylactic acid, polymethyl methacrylate, furan, silicon, and polysulfone, but are not limited thereto. The examples may be used alone or in combination.

Being integrally formed means, for example, that the lip contact part and the second silver nitride sintered-surface layer are formed as a single part in one mold or molding frame. For this, they may be formed as a single part together with other parts. The integrally formed parts may include an additive, such as a flame retardant, a thermal stabilizer, a colorant, a pigment, a compatibilizer, a photo-stabilizer, an impact modifier, and an inorganic filler, in an amount of 0.1 to 5 wt % based on the total weight of the parts.

In the embodiment of the present invention, the integrally formed inner wall and first silver nitride sintered-surface layer, the integrally formed lip contact part and second silver nitride sintered-surface layer, or each of the integrally formed inner wall and first silver nitride sintered-surface layer and the integrally formed lip contact part and second silver nitride sintered-surface layer may include particles including the silver nitride sintered-surface layer in an amount of 1 to 40 parts by weight, 5 to 30 parts by weight, 10 to 20 parts by weight, or 1 to 10 parts by weight based on 100 parts by weight of the plastics. When the inner wall and the first silver nitride sintered-surface layer or the lip contact part and the second silver nitride sintered-surface layer include the particles including the silver nitride sintered-surface layer in an amount that is in any one of the aforementioned ranges, an excellent early antibacterial property may be secured while the formability of the plastic material is not hindered.

In the embodiment of the present invention, the particles including the silver nitride sintered-surface layer may be exposed on the surface of the first silver nitride sintered-surface layer, the second silver nitride sintered-surface layer, or both the first silver nitride sintered-surface layer and the second silver nitride sintered-surface layer. Such exposure means that the particles including the silver nitride sintered-surface layer may come into direct contact with foods, including water, or the lips (including the organs around the mouth and hand-related organs).

In the embodiment of the present invention, the particles including the silver nitride sintered-surface layer may be exposed on the surface of the first silver nitride sintered-surface layer, the second silver nitride sintered-surface layer, or both the first silver nitride sintered-surface layer and the second silver nitride sintered-surface layer by sandblasting.

In the embodiment of the present invention, inner cores of the particles including the silver nitride sintered-surface layer may include talc particles. Talc powder for food additives, for example, talc powder E553b (EU permission number), may be used as the talc particles.

In the embodiment of the present invention, the weight ratio of the talc particles and the silver nitride sintered-surface layer may be 100:1 to 10 or 100:1 to 5.

The inner wall (inner bottle) and the lip contact part may combine to independently constitute the water-preserving container. The water-preserving container may include an outer bottle (see FIG. 1), a handle, a lid, an opening and shutting device, a sensor, and a display device, in addition to the inner wall and the lip contact part.

For example, such as a cup, a portion of the lip contact part or the entire lip contact part may be a portion of the inner wall or the entire inner wall, and a portion of the inner wall or the entire inner wall may be a portion of the lip contact part or the entire lip contact part. An inlet and an outlet for foods including water may be formed in the inner wall, the lip contact part (see FIGS. 1, 2 and 4), or any other parts.

The lip contact part and the inner wall (inner bottle) may be integrally formed, or may be constituted as separate parts. When the lip contact part is constituted as an independent part, the lip contact part and the inner wall may be physically combined by a combination structure of protrusions and recesses or welding, etc., or may be chemically combined by an adhesive, etc., and accordingly, the lip contact part and the inner wall may not be separated when the water-preserving container is in use, in disuse, or both in use and disuse.

Further, when the lip contact part is constituted as an independent part, as shown in FIGS. 1, 2, 3 and 4, the lip contact part may have a cylinder shape and may have a thread on an external surface of the lip contact part, and a portion of the inner wall (inner bottle), which comes into contact with the thread, may have another thread corresponding to the thread on an external surface of the lip contact part to thus make it easy to assemble and disassemble.

Combining or assembling of parts other than the inner wall and the lip contact part, or combining or assembling of the inner wall or the lip contact part and other parts may be the same as combining or assembling of the inner wall and the lip contact part.

Method of Manufacturing the Water-Preserving Container

The method of manufacturing the water-preserving container including the inner wall and the lip contact part according to the embodiment of the present invention may include a first process of adding and dissolving silver salt compound powder to water or a polar organic solvent to manufacture a silver salt-dissolved solution, a second process of applying the silver salt-dissolved solution on a portion of the inner wall or the entire inner wall and a portion of the lip contact part or the entire lip contact part of the water-preserving container, and a third process of sintering a silver salt compound applied on the inner wall and the lip contact part under a nitrogen atmosphere to form a first silver nitride sintered-surface layer on a portion of the inner wall or the entire inner wall and a second silver nitride sintered-surface layer on a portion of the lip contact part or the entire lip contact part.

In the embodiment of the present invention, the material of the inner wall and the lip contact part may comprise a material selected from among metal, glass, ceramics, minerals, and a combination thereof.

Examples of the polar organic solvent include tetrahydrofuran, ethyl acetate, acetone, dimethylformamide, acetonitrile, dimethyl sulfoxide, nitromethane, propylene carbonate, formic acid, butanol, isopropanol, n-propanol, ethanol, methanol, and acetic acid, but are not limited thereto. The examples may be used alone or in combination.

In the embodiment of the present invention, 1 to 5 parts by weight of the silver salt compound powder may be added to 100 parts by weight of water or the polar organic solvent in the first process. For this, the manufactured water-preserving container may have an excellent early antibacterial property.

In the embodiment of the present invention, the silver salt compound may be selected from among silver carbonates, silver chlorates, silver chlorides, silver chromates, silver vanadates, silver manganates, silver nitrates, silver nitrites, silver perchlorates, silver phosphates, silver acetates, and mixtures thereof.

In the embodiment of the present invention, the sintering temperature may be 440° C. or more, for example, 440 to 1,000° C., in the third process. The sintering temperature may depend on the type of silver salt compound and the material of the water-preserving container.

In the embodiment of the present invention, a coarse surface may be formed on a portion of the inner wall or the entire inner wall, a portion of the lip contact part or the entire lip contact part, or a portion of the inner wall or the entire inner wall and a portion of the lip contact part or the entire lip contact part before the second process, and the silver salt-dissolved solution may be applied on a portion of the coarse surface or the entire coarse surface in the second process. Thereby, the strength of adhesion of the silver nitride sintered-surface layer may be improved, and the antibacterial effect due to the silver nitride sintered-surface layer may be improved.

In the embodiment of the present invention, the coarse surface may be formed by sandblasting.

The nitrogen atmosphere means that the atmosphere in the system (for example, furnace body), in which the sintering process is performed, includes nitrogen in an amount of 90 to 100 vol % or 95 to 100 vol %.

In the embodiment of the present invention, the first silver nitride sintered-surface layer may be formed to a thickness of 0.1 to 20 μm and the second silver nitride sintered-surface layer may be formed to a thickness of 0.1 to 20 μm.

In the embodiment of the present invention, the method may include a process of manufacturing (for example, combining or assembling process) the water-preserving container including the inner wall and the lip contact part before the first process, wherein the water-preserving container may include other parts, for example, an outer bottle, a handle, a lid, an opening and shutting device, a sensor, and a display device. The process of combining or assembling the inner wall and the lip contact part, the process of combining or assembling parts other than the inner wall and the lip contact part, or the process of combining or assembling the inner wall or the lip contact part and the other parts is the same as the aforementioned process.

In the embodiment of the present invention, the method may include a fourth process of reducing the temperature of the water-preserving container to room temperature, for example, 20° C., after the third process.

In the embodiment of the present invention, the method may include a fifth process of manufacturing (for example, the combining or assembling process) the water-preserving container including the inner wall and the lip contact part after the third or fourth process, wherein the water-preserving container may include other parts, for example, an outer bottle, a handle, a lid, an opening and shutting device, a sensor, and a display device. The process of combining or assembling the inner wall and the lip contact part, the process of combining or assembling parts other than the inner wall and the lip contact part, or the process of combining or assembling the inner wall or the lip contact part and the other parts is the same as the aforementioned process.

In the embodiment of the present invention, the method may include a process of washing the water-preserving container or a process of washing and drying the water-preserving container after the third, fourth, or fifth process.

The method of manufacturing the water-preserving container including the inner wall and the lip contact part according to the embodiment of the present invention may include a first process of adding and dissolving 1 to 5 parts by weight of silver salt compound powder to 100 parts by weight of water or a polar organic solvent to manufacture a silver salt-dissolved solution, a second process of applying the silver salt-dissolved solution on a portion of the inner wall or the entire inner wall and a portion of the lip contact part or the entire lip contact part of the water-preserving container, and a third process of sintering a silver salt compound applied on the inner wall and the lip contact part under a nitrogen atmosphere or the atmosphere (the air) to form a first silver nitride sintered-surface layer or silver oxide sintered-surface layer on a portion of the inner wall or the entire inner wall and a second silver nitride sintered-surface layer or silver oxide sintered-surface layer on a portion of the lip contact part or the entire lip contact part.

The method of manufacturing the water-preserving container including the inner wall and the lip contact part according to the embodiment of the present invention may include a first process of adding talc powder and silver salt compound powder to water or a polar organic solvent, mixing them, and sintering a silver salt compound under a nitrogen atmosphere to manufacture talc particles including a silver nitride sintered-surface layer, a second process of mixing and heating a plastic material and the talc particles including the silver nitride sintered-surface layer to manufacture pellets, a third process of forming the inner wall, the lip contact part, or both the inner wall and the lip contact part with the pellets, and a fourth process of subjecting a portion of the inner wall or the entire inner wall, a portion of the lip contact part or the entire lip contact part, or a portion of the inner wall or the entire inner wall and a portion of the lip contact part or the entire lip contact part to sandblasting to expose the talc particles including the silver nitride sintered-surface layer on a surface of the inner wall, the lip contact part, or both the inner wall and the lip contact part.

A method of manufacturing a water-preserving container including an inner wall and a lip contact part may comprise: a first process of adding talc powder and silver salt compound powder to water or a polar organic solvent, mixing them, and sintering a silver salt compound at a temperature of 440° C. or more under a nitrogen atmosphere to manufacture talc particles including a silver nitride sintered-surface layer, a second process of mixing and heating a plastic material and the talc particles including the silver nitride sintered-surface layer to manufacture pellets, a third process of injection molding the lip contact part with the pellets, and a fourth process of subjecting a surface of a necessary portion (40) of the lip contact part (30) to sandblasting to expose the talc particles including the silver nitride sintered-surface layer on the surface of the necessary portion of the lip contact part.

Talc powder for food additives, for example, talc powder E553b (EU permission number), may be used as the aforementioned talc powder. The talc particles may have a diameter of 10 to 20 μm.

In the embodiment of the present invention, the silver salt compound may be selected from among silver carbonates, silver chlorates, silver chlorides, silver chromates, silver vanadates, silver manganates, silver nitrates, silver nitrites, silver perchlorates, silver phosphates, silver acetates, and mixtures thereof.

Examples of the polar organic solvent include tetrahydrofuran, ethyl acetate, acetone, dimethylformamide, acetonitrile, dimethyl sulfoxide, nitromethane, propylene carbonate, formic acid, butanol, isopropanol, n-propanol, ethanol, methanol, and acetic acid, but are not limited thereto. The examples may be used alone or in combination.

In the embodiment of the present invention, the weight ratio of the talc powder and the silver salt compound powder may be 100:1 to 10 or 100:1 to 5 and the weight ratio of a mixture of the talc powder and the silver salt compound powder and water or the polar organic solvent may be 1 to 70:100 in the first process. Thereby, the manufactured water-preserving container may represent an excellent early antibacterial property.

The nitrogen atmosphere means that the atmosphere in the system (for example, furnace body), in which the sintering process is performed, includes nitrogen in an amount of 90 to 100 vol % or 95 to 100 vol %.

In the embodiment of the present invention, a sintering temperature may be 440° C. or more, for example, 440 to 1,000° C., in the first process. The sintering temperature may depend on the type of silver salt compound and talc powder.

In the embodiment of the present invention, the weight ratio of the plastic material to the talc particles including the silver nitride sintered-surface layer may be 100:1 to 40, 100:5 to 30, 100:10 to 20, or 100:1 to 20 in the second process. When the weight ratio of the plastic material to the talc particles including the silver nitride sintered-surface layer is in any one of the aforementioned ranges, the manufactured water-preserving container may have an excellent early antibacterial property, while the formability of the plastic material is not hindered.

In the embodiment of the present invention, the method may include a process of reducing the temperature of the talc particles including the silver nitride sintered-surface layer to room temperature, for example, 20° C., after the first process.

In the embodiment of the present invention, the method may include a fifth process of manufacturing (for example, combining or assembling process) the water-preserving container including the inner wall and the lip contact part after the fourth process, wherein the water-preserving container may include other parts, for example, an outer bottle, a handle, a lid, an opening and shutting device, a sensor, and a display device. The process of combining or assembling the inner wall and the lip contact part, the process of combining or assembling parts other than the inner wall and the lip contact part, or the process of combining or assembling the inner wall or the lip contact part and the other parts is the same as the aforementioned process.

In the embodiment of the present invention, the method may include a process of washing the water-preserving container or a process of washing and drying the water-preserving container after the fifth process.

The method of manufacturing the water-preserving container including the inner wall and the lip contact part according to the embodiment of the present invention may include a first process of adding talc powder and silver salt compound powder to water or a polar organic solvent, mixing them, and sintering a silver salt compound under a nitrogen atmosphere or the atmosphere (the air) to manufacture talc particles including a silver nitride sintered-surface layer or silver oxide sintered-surface layer, wherein the weight ratio of the talc powder to the silver salt compound powder is 100:1 to 10 or 100:1 to 5 and the weight ratio of a mixture of the talc powder and the silver salt compound powder to the water or the polar organic solvent is 1 to 70:100, a second process of mixing and heating a plastic material and the talc particles including the silver nitride sintered-surface layer or silver oxide sintered-surface layer to manufacture pellets, a third process of forming the inner wall, the lip contact part, or both the inner wall and the lip contact part with the pellets, and a fourth process of subjecting a portion of the inner wall or the entire inner wall, a portion of the lip contact part or the entire lip contact part, or a portion of the inner wall or the entire inner wall and a portion of the lip contact part or the entire lip contact part to sandblasting to expose the talc particles including the silver nitride sintered-surface layer or silver oxide sintered-surface layer on the surface of the inner wall, the lip contact part, or both the inner wall and the lip contact part.

### EXAMPLE

Hereinafter, the present invention is specifically described together with the following examples. The following examples are set forth to specifically illustrate the present invention, but are not to be construed to limit the scope of the present invention.

### Comparative Example 1

A silver-sintered vacuum bottle was used for testing.

Antibacterial Test of Non-Silver Oxide Bottle

The following antibacterial test was performed by Japan Food Research Laboratories upon request. The antibacterial ability of the silver-sintered vacuum bottle to E. coli was tested.

Specimen: 200 mL of mineral water including E. coli were added to the silver-sintered vacuum bottle, and then left

Control: 200 mL of purified water including E. coli were added to the sterilized container made of the synthetic resin, and then left

Counts of E. coli were taken over time while the specimen and the control were maintained at 20° C., and the result is described in the following Table 1.

TABLE 1

| | | Viable cell count (cells/mL) | | | |
|---|---|---|---|---|---|
| | | At the | | | |
| Test | | time of | After | After 3 | After 6 |
| organisms | Subject | initiation | 1 hour | hours | hours |
| Escherichia | Specimen | 4.2 × 10⁵ | 2.8 × 10⁵ | 1.8 × 10⁵ | 6.3 × 10⁴ |
| coli NBRC | Control | 4.2 × 10⁵ | 3.3 × 10⁵ | 4.4 × 10⁵ | 4.7 × 10⁵ |
| 3972 | | | | | |

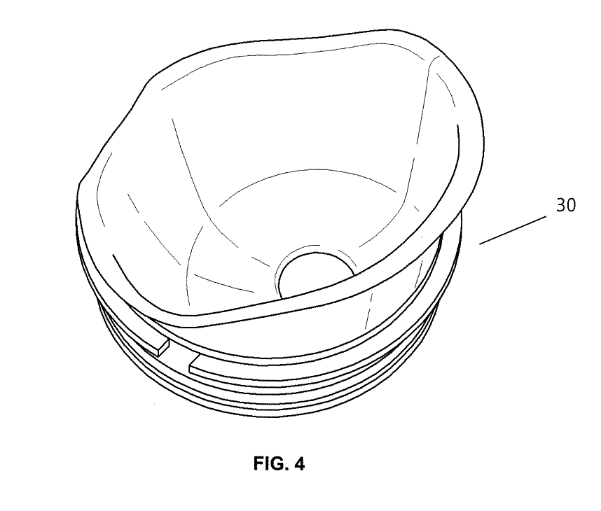

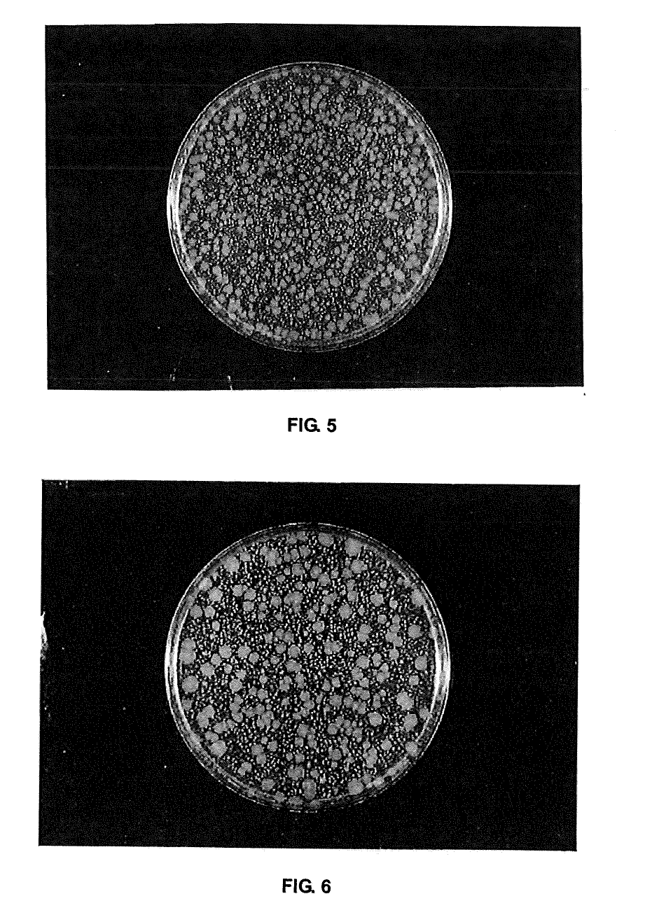

0.1 mL of the test solution was sampled and then photographed at the time of initiation, after 3 hours, and after 6 hours, and the pictures are shown in FIGS. 5, 6, and 7.

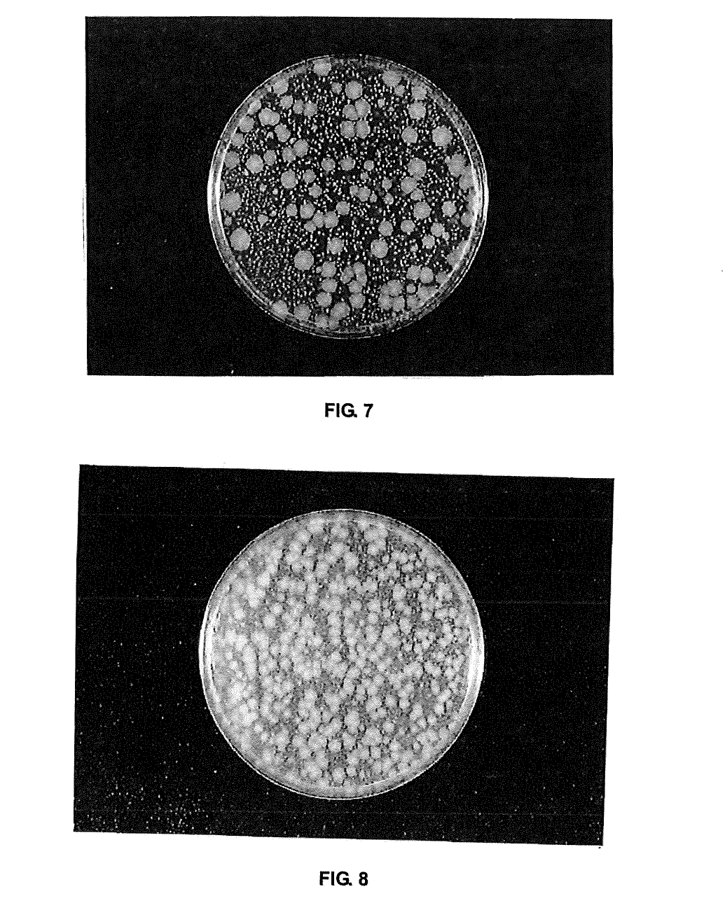

From Table 1 and FIG. 7, it can be seen that few E. coli were destroyed even 6 hours after mineral water including E. coli was added to the silver-sintered vacuum bottle for testing.

### Reference Example 1

As shown in FIG. 1, a cylindrical vacuum water bottle (height: 20 cm and diameter: 5 cm), which included an inner wall (made of stainless steel) having a threaded upper portion, an outer bottle (made of stainless steel), a vacuum part between the inner wall and the outer bottle, and an externally threaded lip contact part (made of an aluminum alloy), was manufactured. 1.5 parts by weight of silver nitrate powder was added and dissolved to 100 parts by weight of water to prepare silver nitrate aqueous solution. The silver nitrate aqueous solution was applied on the inner wall and the lip contact part of the vacuum water bottle. The applied portion was sintered under the atmosphere at 440° C. for 120 min to form the first silver oxide sintered-surface layer on the inner wall and the second silver oxide sintered-surface layer on the lip contact part, and the temperature was then reduced to 20° C. The vacuum water bottle was washed with water and then dried at room temperature to manufacture a vacuum water bottle including an inner wall and a lip contact part on which the silver oxide sintered-surface layer was formed.

Antibacterial Test of Silver Oxide Vacuum Water Bottle

The following antibacterial test was performed by Japan Food Research Laboratories upon request. The antibacterial ability of the manufactured silver oxide vacuum water bottle to E. coli was tested.

Specimen 1): 200 mL of mineral water including E. coli was added to the silver oxide vacuum water bottle and then left

Specimen 2): 200 mL of mineral water including E. coli was added to the silver oxide vacuum water bottle, and then the silver oxide vacuum water bottle was turned upside down

Control: 200 mL of purified water including E. coli was added to the sterilized container made of the synthetic resin, and then left

Counts of E. coli were taken over time while the specimens and the control were maintained at 20° C., and the result is described in the following Table 2.

TABLE 2

| | | Viable cell count (cells/mL) | | |
|---|---|---|---|---|
| | | At the time of | After 3 | After 6 |
| Test organisms | Subject | initiation | hours | hours |
| Escherichia coli | Specimen 1) | 3.6 × 10⁵ | 1.6 × 10² | <10 |
| NBRC 3972 | Specimen 2) | 3.6 × 10⁵ | 2.1 × 10² | <10 |
| | Control | 3.6 × 10⁵ | 3.6 × 10⁵ | 4.0 × 10⁵ |

<10: Not detected

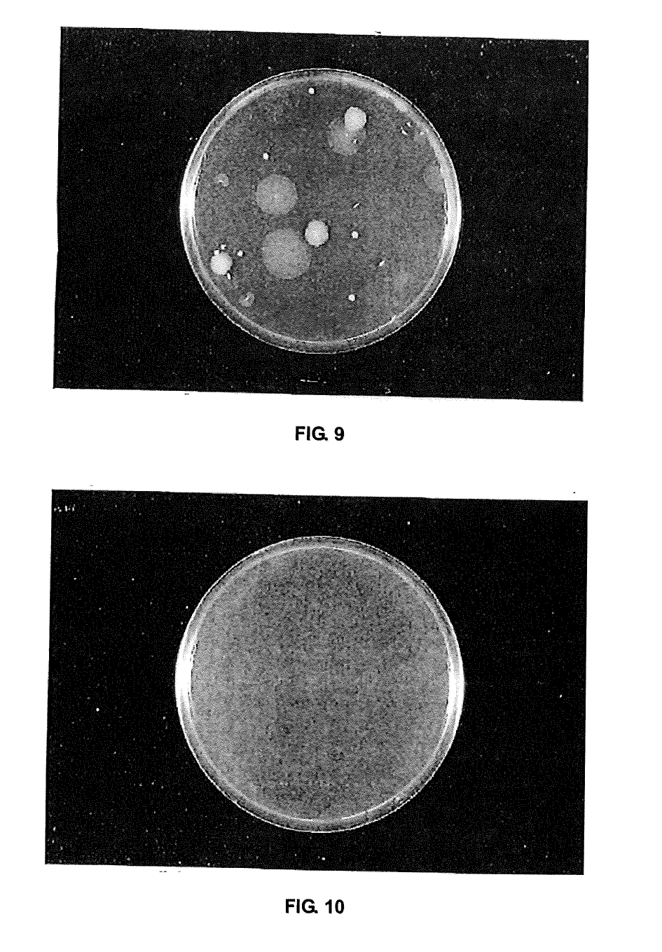

0.1 mL of the test solution was sampled and then photographed at the time of initiation, after 3 hours, and after 6 hours, and the pictures are shown in FIGS. 8, 9, and 10.

From Table 2 and FIG. 10, it can be seen that E. coli was completely destroyed 6 hours after mineral water including E. coli was added to the silver oxide vacuum water bottle.

### Example 1

As shown in FIG. 1, a cylindrical vacuum water bottle (height: 20 cm and diameter: 5 cm), which included an inner wall (made of stainless steel) having a threaded upper portion, an outer bottle (made of stainless steel), a vacuum part between the inner wall and the outer bottle, and an externally threaded lip contact part (made of an aluminum alloy), was manufactured. 1.5 parts by weight of silver nitrate powder was added and dissolved to 100 parts by weight of water to prepare the silver nitrate aqueous solution. The silver nitrate aqueous solution was applied on the inner wall and the lip contact part of the vacuum water bottle. The applied portion was sintered under a nitrogen atmosphere (99 to 100 vol % of nitrogen) at 440° C. for 120 min to form the first silver nitride sintered-surface layer on the inner wall and the second silver nitride sintered-surface layer on the lip contact part, and the temperature was reduced to 20° C. The vacuum water bottle was washed with water and then dried at room temperature to manufacture the vacuum water bottle including the inner wall and the lip contact part on which the silver nitride sintered-surface layer was formed.

Antibacterial Test of Silver Nitride Vacuum Water Bottle

The following antibacterial test was performed by Japan Food Research Laboratories upon request. The antibacterial ability of the manufactured silver nitride vacuum water bottle to E. coli was tested.

Specimen: 200 mL of mineral water including E. coli was added to the silver nitride vacuum water bottle, and then left

Control: 200 mL of purified water including E. coli was added to a sterilized container made of synthetic resin, and then left

Counts of E. coli were taken over time while the specimen and the control were maintained at 20° C., and the result is described in the following Table 3.

TABLE 3

| | | Viable cell count (cells/mL) | | | |
|---|---|---|---|---|---|
| | | At the | | | |
| Test | | time of | After 2 | After 3 | After 4 |
| organisms | Subject | initiation | hours | hours | hours |
| Escherichia | Specimen | 6.4 × 10⁵ | <10 | <10 | <10 |
| coli NBRC | Control | 6.4 × 10⁵ | 6.1 × 10⁵ | 7.0 × 10⁵ | 7.0 × 10⁵ |
| 3972 | | | | | |

<10: Not detected

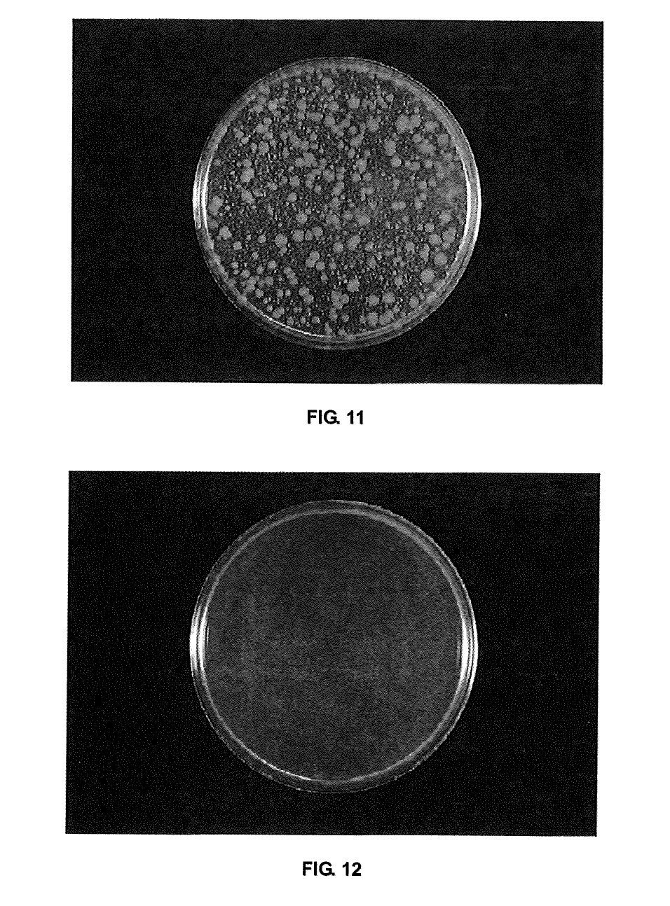

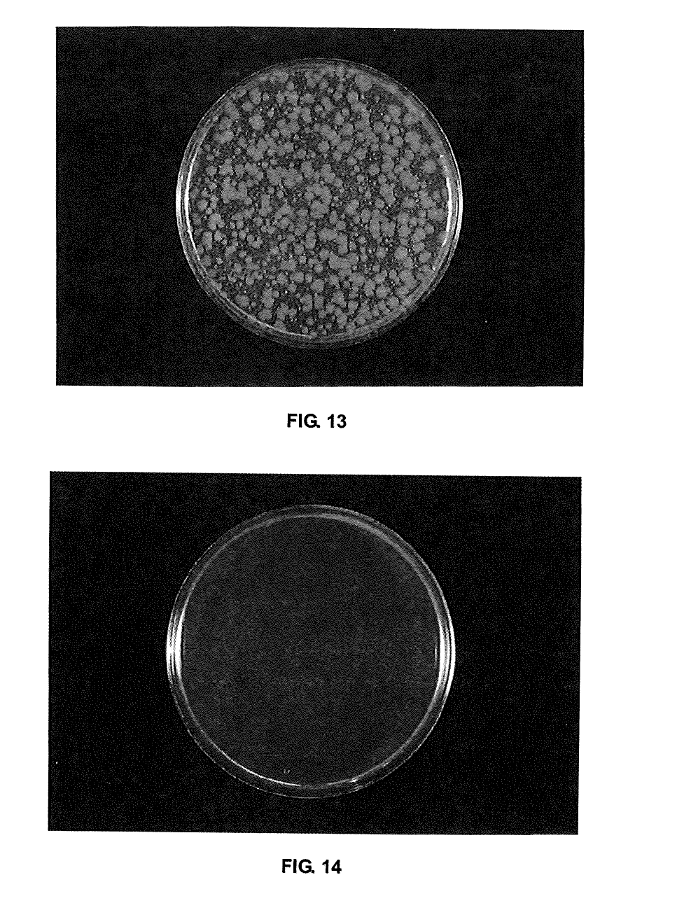

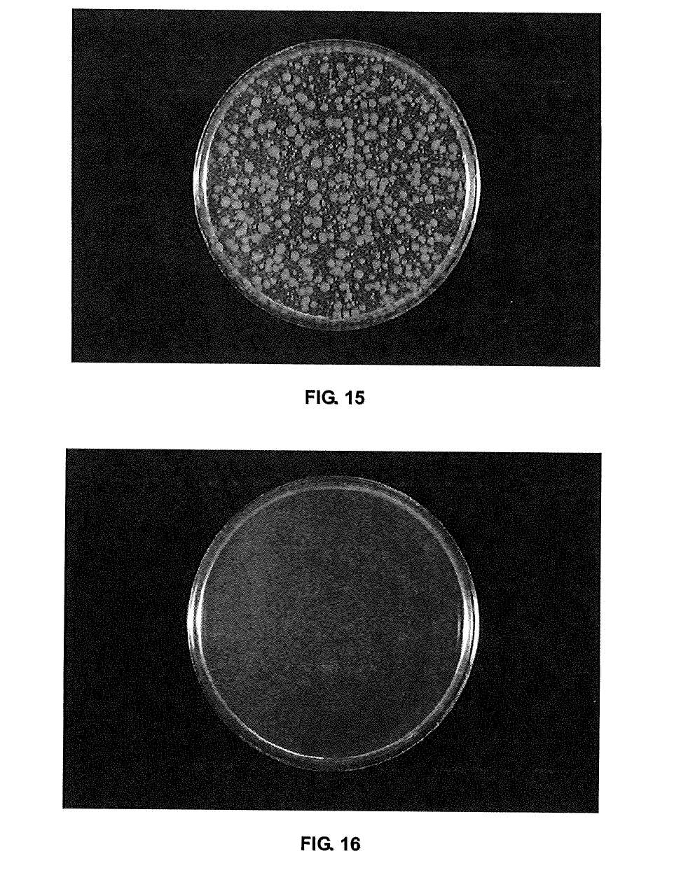

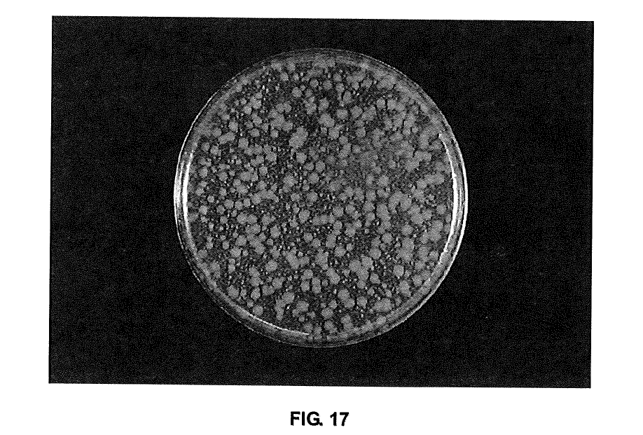

For the Specimen and Control, 0.1 mL of the test solution was sampled and then photographed at the time of initiation and after 2 hours, 3 hours and 4 hours, and the pictures are shown in FIGS. 11 to 17.

From Table 3 and FIG. 12, it can be seen that E. coli was completely destroyed 2 hours after mineral water including E. coli was added to the silver nitride vacuum water bottle.

### Example 2

A plate made of stainless steel (10 cm×10 cm×1 cm) was manufactured. 1.5 parts by weight of silver nitrate powder was added and dissolved to 100 parts by weight of water to prepare the silver nitrate aqueous solution. The silver nitrate aqueous solution was applied on the plate. The applied portion was sintered under a nitrogen atmosphere (99 to 100 vol % of nitrogen) at 440° C. for 120 min to form the silver nitride sintered-surface layer on the plate, and the temperature was reduced to 20° C. The plate was washed with water and then dried at room temperature to manufacture the plate including the silver nitride sintered-surface layer thereon.

Antibacterial Test of Silver Nitride Plate

The following antibacterial test was performed by Japan Food Research Laboratories upon request. The antibacterial ability of the manufactured silver nitride plate to Streptococcus mutans was tested.

Specimen: 200 mL of mineral water including Streptococcus mutans was added on the silver nitride plate, and then left

Control: 200 mL of purified water including Streptococcus mutans was added on a polyethylene film, and then left

Counts of Streptococcus mutans were taken over time while the specimen and the control were maintained at 35° C., and the result is described in the following Table 4.

TABLE 4

| | | | Viable cell count (cells/1 cm²) | | |
|---|---|---|---|---|---|
| | | | 1^{st} | 2^{nd} | 3^{rd} |
| Test organisms | Measurement | Subject | measurement | measurement | measurement |
| Streptococcus | At the time of | Control | 1.3 × 10⁴ | 1.5 × 10⁴ | 1.2 × 10⁴ |
| mutans | initiation | | | | |
| | After 3 hours | Specimen | <0.63 | <0.63 | <0.63 |
| | | Control | 1.6 × 10⁴ | 1.6 × 10⁴ | 1.5 × 10⁴ |

<0.63: Not detected

From Table 4, it can be seen that Streptococcus mutans was completely destroyed 3 hours after mineral water including Streptococcus mutans was added on the silver nitride plate.

To sum up, from test data from Japan Food Research Laboratories, it was confirmed that the silver nitride vacuum water bottle according to the embodiment of the present invention had excellent ability to remove anaerobic bacteria, such as food-poisoning bacteria (particularly, E. coli O-157 and O-111, Vibrio parahaemolyticus, Staphylococcus aureus, and Salmonella) or Streptococcus mutans, among bacteria that are harmful to the human body. For comparison of the antibacterial performances of the silver coats, when the antibacterial performances of the silver oxide coat and the silver nitride coat were compared with regard to the reduction in realization time of the antibacterial performance, the antibacterial performances were considered to be about three times different even when using the same amount of silver, and accordingly, the silver nitride coat was better. It was confirmed that with regard to the silver nitride coat bacteria were destroyed in a short time, equal to about one third of that of the silver oxide coat, and an antibacterial property was secured within 2 hours.

Meanwhile, since the antibacterial effect of silver is very slowly realized, an early antibacterial effect cannot be expected.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A water-preserving container comprising:
a first silver nitride (Ag₃N) sintered-surface layer on a portion of an inner wall or the entire inner wall of the water-preserving container, and
a second silver nitride sintered-surface layer on a portion of a lip contact part or the entire lip contact part of the water-preserving container.

2. The water-preserving container of claim 1, wherein a portion of the inner wall or the entire inner wall beneath the first silver nitride sintered-surface layer, a portion of the lip contact part or the entire lip contact part beneath the second silver nitride sintered-surface layer, or a portion of the inner wall or the entire inner wall beneath the first silver nitride sintered-surface layer and a portion of the lip contact part or the entire lip contact part beneath the second silver nitride sintered-surface layer have a coarse surface.

3. The water-preserving container of claim 2, wherein the coarse surface is formed by sandblasting.

4. The water-preserving container of claim 1, wherein the first silver nitride sintered-surface layer has a thickness of 0.1 to 20 μm, and the second silver nitride sintered-surface layer has a thickness of 0.1 to 20 μm.

5. The water-preserving container of claim 1, wherein a portion of the inner wall or the entire inner wall, a portion of the lip contact part or the entire lip contact part, or a portion of the inner wall or the entire inner wall and a portion of the lip contact part or the entire lip contact part include a material including the plastics, and are integrally formed with the first silver nitride sintered-surface layer, the second silver nitride sintered-surface layer, or each of the first silver nitride sintered-surface layer and the second silver nitride sintered-surface layer.

6. The water-preserving container of claim 5, wherein the integrally formed inner wall and first silver nitride sintered-surface layer, the integrally formed the lip contact part and second silver nitride sintered-surface layer, or each of the integrally formed inner wall and first silver nitride sintered-surface layer and the integrally formed lip contact part and second silver nitride sintered-surface layer include 1 to 40 parts by weight of particles including a silver nitride sintered-surface layer based on 100 parts by weight of the plastics.

7. The water-preserving container of claim 6, wherein the particles including the silver nitride sintered-surface layer are exposed on the surface of the first silver nitride sintered-surface layer, the second silver nitride sintered-surface layer, or both the first silver nitride sintered-surface layer and the second silver nitride sintered-surface layer.

8. The water-preserving container of claim 6, wherein inner cores of the particles including the silver nitride sintered-surface layer include talc particles.

9. The water-preserving container of claim 8, wherein the weight ratio of the talc particles to the silver nitride sintered-surface layer is 100:1 to 10.

10. A method of manufacturing a water-preserving container including an inner wall and a lip contact part, comprising:
a first process of adding and dissolving silver salt compound powder to water or a polar organic solvent to manufacture a silver salt-dissolved solution,
a second process of applying the silver salt-dissolved solution on a portion of the inner wall or the entire inner wall and a portion of the lip contact part or the entire lip contact part of the water-preserving container, and
a third process of sintering a silver salt compound applied on the inner wall and the lip contact part under a nitrogen atmosphere to form a first silver nitride sintered-surface layer on a portion of the inner wall or the entire inner wall and a second silver nitride sintered-surface layer on a portion of the lip contact part or the entire lip contact part.

11. The method of manufacturing a water-preserving container of claim 10, wherein 1 to 5 parts by weight of the silver salt compound powder are added to 100 parts by weight of water or the polar organic solvent in the first process.

12. The method of manufacturing a water-preserving container of claim 10, wherein the silver salt compound is selected from among silver carbonates, silver chlorates, silver chlorides, silver chromates, silver vanadates, silver manganates, silver nitrates, silver nitrites, silver perchlorates, silver phosphates, silver acetates, and mixtures thereof.

13. The method of manufacturing a water-preserving container of claim 10, wherein the sintering temperature is 440° C. or more in the third process.

14. The method of manufacturing a water-preserving container of claim 10, wherein a coarse surface is formed on a portion of the inner wall or the entire inner wall, a portion of the lip contact part or the entire lip contact part, or a portion of the inner wall or the entire the inner wall and a portion of the lip contact part or the entire lip contact part before the second process, and the silver salt-dissolved solution is applied on a portion of the coarse surface or the entire coarse surface in the second process.

15. The method of manufacturing a water-preserving container of claim 14, wherein the coarse surface is formed by sandblasting.

16. A method of manufacturing a water-preserving container including an inner wall and a lip contact part, comprising:
a first process of adding talc powder and silver salt compound powder to water or a polar organic solvent, mixing them, and sintering a silver salt compound at a temperature of 440° C. or more under a nitrogen atmosphere to manufacture talc particles including a silver nitride sintered-surface layer,
a second process of mixing and heating a plastic material and the talc particles including the silver nitride sintered-surface layer to manufacture pellets,
a third process of injection molding the lip contact part with the pellets, and
a fourth process of subjecting a surface of a necessary portion of the lip contact part to sandblasting to expose the talc particles including the silver nitride sintered-surface layer on the surface of the necessary portion of the lip contact part.

17. The method of manufacturing a water-preserving container of claim 16, wherein the weight ratio of the talc powder to the silver salt compound powder is 100:1 to 10, and the weight ratio of the mixture of the talc powder and the silver salt compound powder to the water or the polar organic solvent is 1 to 70:100 in the first process.

18. The method of manufacturing a water-preserving container of claim 16, wherein the silver salt compound is selected from among silver carbonates, silver chlorates, silver chlorides, silver chromates, silver vanadates, silver manganates, silver nitrates, silver nitrites, silver perchlorates, silver phosphates, silver acetates, and mixtures thereof.

19. The method of manufacturing a water-preserving container of claim 16, wherein the weight ratio of the plastic material to the talc particles including the silver nitride sintered-surface layer is 100:1 to 40 in the second process.
